(19) United States
(12) Patent Application Publication
(10) Pub. No.: US 2018/0314948 A1
(43) Pub. Date: Nov. 1, 2018

(54) GENERATING MULTIPLE LANGUAGE TRAINING DATA FOR SEACH CLASSIFIER

(71) Applicant: Google Inc., Mountain View, CA (US)

(72) Inventor: Robin Nittka, Zurich (CH)

(21) Appl. No.: 14/750,080

(22) Filed: Jun. 25, 2015

(51) Int. Cl. G06N 5/02; G06F 17/30

(52) U.S. Cl. CPC G06N 5/022; G06F 17/30244; G06F 17/30834

(57) ABSTRACT

A system and method for training a search query classifier may be used to develop a large database of search queries used to access inappropriate sensitive or offensive content in multiple languages.

### FIELD

This disclosure generally relates to search engines.

### BACKGROUND

Internet users can search for various types of content using search engines. Internet content may include sensitive or offensive content such as, for example, child pornography, gore scenes and images, terrorist or gang recruitment content, and spoof content. Because users may, in some cases, involuntarily receive the sensitive or offensive content, it is important to identify search queries for the sensitive or offensive content and to configure search results to limit exposure to certain types of the sensitive or offensive content. In addition, since search for sensitive or offensive content may be conducted in multiple languages, a multiple language approach to the identification of search queries for inappropriate sensitive or offensive content may be needed.

### SUMMARY

This disclosure generally describes a method and system for training a classifier to identify search queries seeking inappropriate sensitive or offensive content in multiple languages.

According to implementations, a collection of frequently-used search queries for child-related content in a first language (e.g., English language) is obtained. Terms in the frequently-used search queries are translated to a second language. Search queries in the second language are then processed to identify frequently-used search queries in the second language that include one or more of the translated terms and one or more terms related to inappropriate sensitive or offensive content (e.g., pornography). The identified frequently-used search queries in the second language are verified and substrings in the verified search queries are extracted. Each of the extracted substrings are classified to determine whether the substring is related to inappropriate sensitive or offensive content. This determination may be based on a number of times the substring is included in search queries seeking inappropriate sensitive or offensive content relative to the number of times the substring appears in any search query. A substring determined to be related to inappropriate sensitive or offensive content is then utilized to identify all search queries that include the substring. These identified search queries are then used as training data to train a search query classifier to identify search queries in a second language that are seeking inappropriate sensitive or offensive content. One of the several advantages of the implementations described herein is that search query classifiers can be trained in multiple languages in a cost-effective, efficient, and largely automated manner.

Innovative aspects of the subject matter described in this specification may, in some implementations, be a non-transitory computer-readable storage medium that includes instructions, which, when executed by one or more computers, cause the one or more computers to perform actions. The actions include obtaining a set of terms related to a particular type of content in a second language based on search queries in a first language and obtaining search queries in the second language that include (i) a substring matching one or more terms related to the particular type of content in the second language and (ii) a substring in the second language related to a subset of the particular type of content. One or more substrings in the obtained search queries that include (i) the substring matching one or more terms related to the particular type of content in the second language and (ii) the substring in the second language related to the subset of the particular type of content, are classified as being related to inappropriate sensitive or offensive content. The classified one or more substrings are provided as training data for training a classifier. The classifier is trained to classify search queries in the second language that contain the classified one or more substrings as attempting to seek the inappropriate sensitive or offensive content.

In some implementations, the particular type of content corresponds to child-related content, the subset of the particular type of content corresponds to child pornography, and the inappropriate sensitive of offensive content corresponds to images, video, and data that include child pornography.

In some implementations, obtaining the set of child-related terms in the second language based on search queries in the first language includes obtaining a first collection of terms related to the particular type of content in the first language. The search queries in the first language that include one of more of the terms related to the particular type of content are identified from among a collection of search queries in the first language. Terms included in the search queries that include the one of more of the terms related to the particular type of content are translated to terms in the second language.

In some implementations, obtaining search queries in the second language that include (i) the substring matching one or more terms related to the particular type of content in the second language and (ii) the substring in the second language related to a subset of the particular type of content includes performing determinations for each search query. The determinations include determining a number of times that the search query is listed in a collection of search queries in the second language, and determining that the number of times satisfies a first threshold.

In some implementations, classifying one or more substrings in the obtained search queries that include (i) the substring matching one or more terms related to the particular type of content in the second language and (ii) the substring in the second language related to the subset of the particular type of content, as being related to inappropriate sensitive or offensive content, includes generating a set of one or more substrings extracted from each of the obtained search queries. For each substring in the set of one or more substrings, (i) a frequency of occurrence of the substring in a collection of search queries in the second language, and (ii) a frequency of occurrence of the substring in search queries in the second language that are classified as related to the subset of the particular type of content are determined. A substring is classified as being related to inappropriate sensitive or offensive content, or not being related to inappropriate sensitive or offensive content, based at least on (i) the frequency of occurrence of the substring in the collection of search queries in the second language, and (ii) the frequency of occurrence of the substring in search queries in the second language that are classified as related to the subset of the particular type of content.

In some implementations, providing the classified one or more substrings as training data for training the classifier to classify search queries in the second language that contain the classified one or more substrings as attempting to seek the inappropriate sensitive or offensive content, includes: identifying one or more search queries that include the one or more substrings classified as being related to inappropriate sensitive or offensive content in a collection of search queries in the second language. The identified one or more search queries are provided as training data to the classifier.

In some implementations, the one or more computers also train the classifier, for a third language, to identify search queries in the third language that contain one or more substrings classified as being related to the inappropriate sensitive or offensive content based on one or more of (i) the search queries in the first language, or (ii) the training data for the second language.

In some implementations, a computer-implemented method includes actions of obtaining a first collection of one or more child-related terms in a first language and identifying, from among a collection of search queries in a first language received from a search engine, a first set of search queries that each include one or more of the child-related terms. A second collection of search terms is generated in a second language based on the first set of search queries from the first language. A second set of search queries in the second language is identified from among a collection of search queries in the second language received from the search engine. For each of the search queries in the second set, a determination is made as to whether the search query includes (i) a substring corresponding to a term in the second collection of search terms, and (ii) a substring corresponding to a term in the second language associated with child pornography. Each of the search queries in the second set that is determined as including (i) a substring corresponding to a term in the second collection of search terms, and (ii) a substring corresponding to a term in the second language associated with child pornography, is classified as being (i) related to child pornography, or (ii) not related to child pornography. A set of one or more substrings is generated from each of the search queries that are classified as related to child pornography. For each substring in the set of one or more substrings, (i) a frequency of occurrence of the substring in the collection of search queries in the second language that were received from the search engine, and (ii) a frequency of occurrence of the substring in the search queries that are classified as related to child pornography are determined. For each substring in the set of one or more of substrings, the substring is classified as (i) a child pornography-related substring or (ii) not a child-pornography-related substring, based at least on (i) the frequency of occurrence of the substring in the collection of search queries in the second language that were received from the search engine, and (ii) the frequency of occurrence of the substring in the search queries that are classified as related to child pornography. In the second set of search queries in the second language, a subset of the search queries that each include one or more of the substrings that are classified as a child pornography-related substring is identified. The subset of the search queries that each include one or more of the substrings classified as child pornography-related substrings are provided as training data for training a classifier.

In some implementations, identifying, from among the collection of search queries in the first language received from the search engine, the first set of search queries that each include one or more of the child-related terms includes determining a number of times that the search queries in the first language are submitted by users of the search engine, and determining that the number of times satisfies a first particular threshold.

In some implementations, identifying the second set of search queries in the second language from among the collection of search queries in the second language received from the search engine includes determining a number of times that the search queries in the second language are submitted by users of the search engine, and determining that the number of times satisfies a second particular threshold.

In some implementations, generating the second collection of search terms in the second language based on the first set of search queries from the first language includes translating the first set of search queries from the first language to the second collection of search terms in the second language.

In some implementations, the computer-implemented method also includes determining that a subsequent search query in the second language is received by the search engine. The subsequent search query includes the one or more of the substrings that are classified as a child pornography-related substring. One or more search queries in the second language that are received by the search engine within a determined period of time of receiving the subsequent search query are identified. The one or more search queries in the second language that are received by the search engine within the determined period of time of receiving the subsequent search query are provides as training data for training the classifier.

In some implementations, classifying the substring as (i) a child pornography-related substring or (ii) not a child-pornography-related substring includes determining a ratio of (i) the frequency of occurrence of the substring in the collection of search queries in the second language that were received from the search engine to (ii) the frequency of occurrence of the substring in the search queries that are classified as related to child pornography. The substring is classified as (i) a child pornography-related substring or (ii) not a child-pornography-related substring based on the ratio satisfying a third particular threshold.

In some implementations, a system includes one or more computers and one or more storage devices storing instructions that are operable and when executed by one or more computers, cause the one or more computers to perform actions. The actions include obtaining a set of terms related to a particular type of content in a second language based on search queries in a first language and obtaining search queries in the second language that include (i) a substring matching one or more terms related to the particular type of content in the second language and (ii) a substring in the second language related to a subset of the particular type of content. One or more substrings in the obtained search queries that include (i) the substring matching one or more terms related to the particular type of content in the second language and (ii) the substring in the second language related to the subset of the particular type of content, are classified as being related to inappropriate sensitive or offensive content. The classified one or more substrings are provided as training data for training a classifier. The classifier is trained to classify search queries in the second language that contain the classified one or more substrings as attempting to seek the inappropriate sensitive or offensive content.

In some implementations, search queries in the second language that satisfy one or more criterion and are verified may be provided as reference queries. The verification of the search queries may be performed using, for example, a filter, algorithm, or combination thereof. In some implementations, search queries in the second language that have been identified as including one or more substrings related to inappropriate sensitive or offensive content may be provided as reference queries. The reference queries may be used to detect co-occurring queries and obtain additional training data to train a search query classifier.

Other embodiments of these aspects include corresponding systems, apparatus, and computer programs, configured to perform the actions of the methods, encoded on computer storage devices.

The details of one or more embodiments are set forth in the accompanying drawings and the description below. Other features and advantages will become apparent from the description, the drawings, and the claims.

### BRIEF DESCRIPTION OF THE DRAWINGS

FIG. 1 depicts a flowchart illustrating a method for training a classifier to identify search queries seeking inappropriate sensitive or offensive content.

FIG. 2 depicts a flowchart illustrating a method for the operation in FIG. 1 to obtain seed terms and queries.

FIG. 3 depicts a flowchart illustrating a method for the operation in FIG. 1 of labelling a co-occurring query.

FIG. 4 depicts a flowchart illustrating a method for displaying search results using the trained classifier.

FIG. 5 depicts a flowchart illustrating a method for expanding a database of search queries seeking inappropriate sensitive or offensive content in multiple languages.

FIG. 6 depicts a flowchart illustrating a method for the operation in FIG. 5 of translating terms in a set of search queries seeking a particular content type from a first language to a second language.

FIG. 7 depicts a flowchart illustrating a method for the operation in FIG. 5 of obtaining search queries in a second language that are related to inappropriate sensitive or offensive content.

FIG. 8 depicts a flowchart illustrating a method for the operation in FIG. 5 of training a search query classifier.

FIG. 9 depicts a block diagram illustrating a system for training a classifier to identify search queries seeking inappropriate sensitive or offensive content.

Like reference numbers and designation in the various drawings indicate like elements.

### DETAILED DESCRIPTION

This disclosure generally describes a method and system for training a classifier to identify search queries seeking inappropriate sensitive or offensive content in multiple languages.

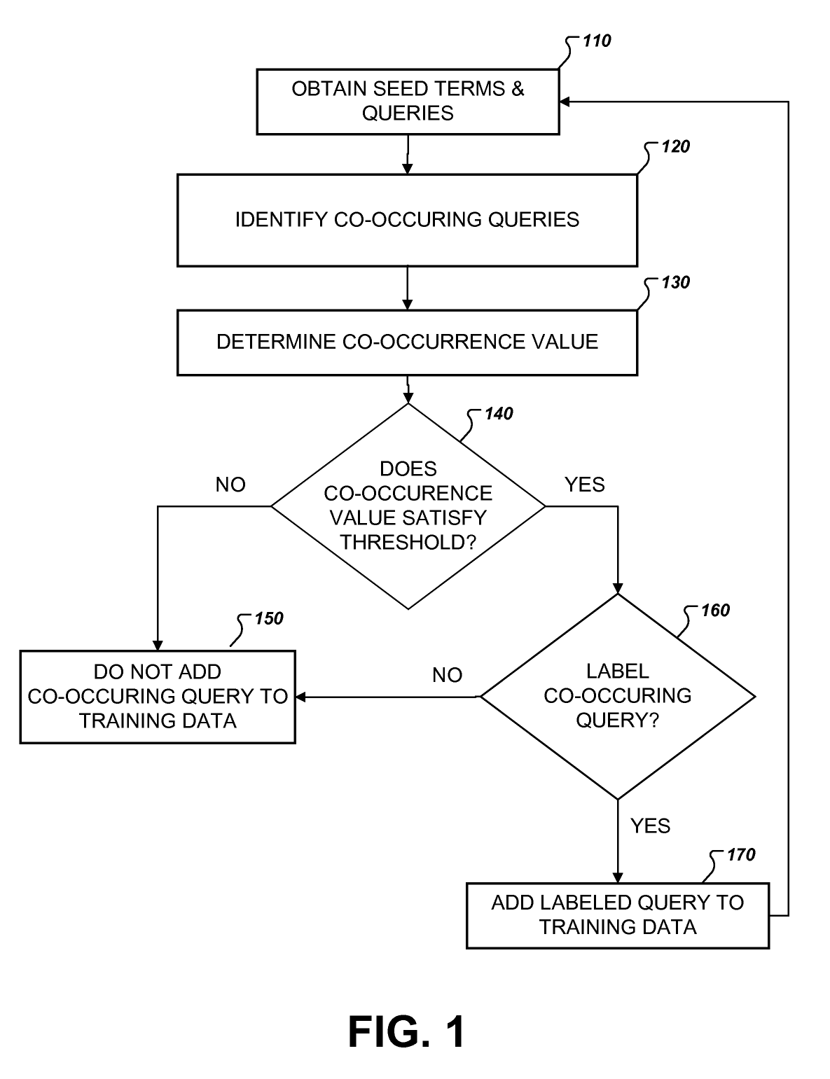

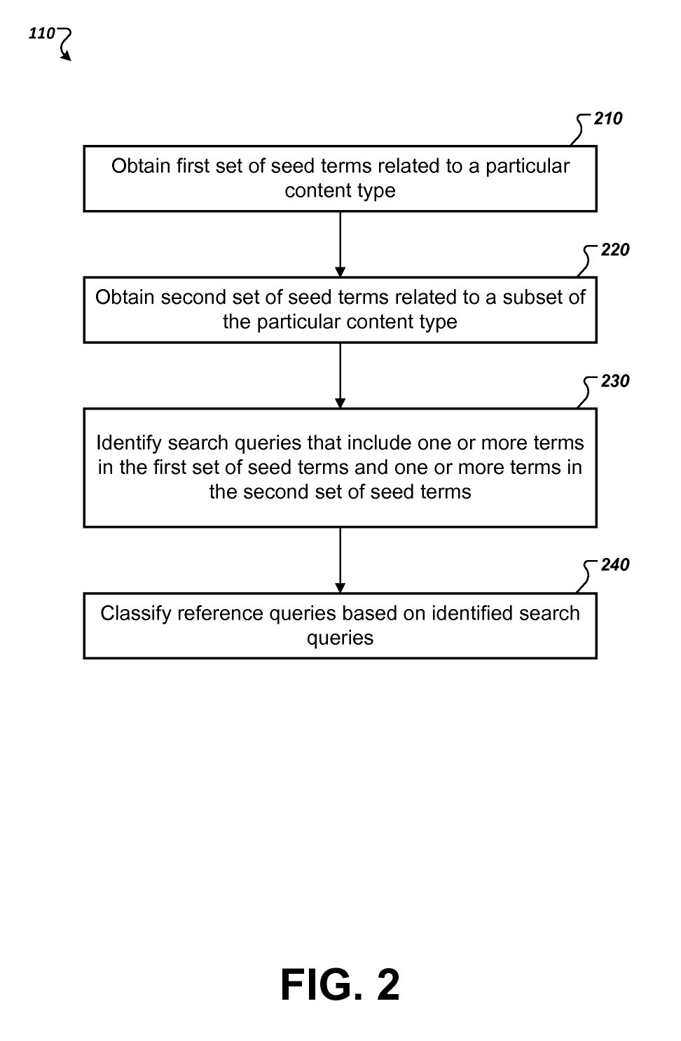

Referring to FIGS. 1 and 2, to train a classifier, initially seed terms and queries are obtained (110). In particular, a collection of a first set of seed terms related to a particular content type (210) and a collection of a second set of seed terms related to a subset of the particular content type (220) may be obtained.

The particular content type may be a content type selected from any subject matter of interest. The subject matter of interest may be determined by an administrator of the search query classifier. For example, in some cases, the particular content may generally relate to children, and the first set of seed terms may be any term associated with children. In the example of children, this first set of seed terms may include, for example, terms such as “teen,” “teenager,” “kindergarten,” and “infant.” It should be understood that various terms associated with a particular content may be obtained, and that the association of terms with particular content may change over time.

The subset of particular content type may include one or more subject matter categories of inappropriate sensitive or offensive content associated with the particular content type. For example, in some cases, the subset of particular content may generally relate to violence, and the second set of seed terms may be any term associated with violence. In the example of a “violence” subset, this second set of seed terms may include, for example, terms such as “gun,” “rifle,” “bomb,” and “gang.”

In another example, the subset of particular content may generally relate to pornography, and the second set of seed terms may be any term associated with pornography. In the example of pornography, the second set of seed terms may include, for example, terms such as “porn,” “rape,” and “sex.” In general, it should be understood that various terms associated with the subset of particular content may be obtained, and that the association of terms with subset of particular content may change over time.

It should be appreciated that although example of particular types of subject matter are provided in this disclosure, these examples are not meant to be limiting. The particular content and subset of particular content may include various types of content.

Next, search queries that include one or more terms of the first set of seed terms and one or more terms of the second set of seed terms are identified (230). Various suitable methods may be used to identify the search queries that include one or more terms of the first set of seed terms and one or more terms of the second set of seed terms. For example, in some implementations, search logs or databases of search query entries may be searched using, for example, a keyword match, to identify search query entries in the search logs or the databases of search entries with terms that match one or more terms of the first set of seed terms and one or more terms of the second set of seed terms. The identified search query entries are extracted from the search logs or the databases of search entries for further processing.

In some implementations, a search frequency of the identified search query entries is determined and only the identified search query entries that have been searched a number of times that satisfies a particular threshold are extracted. For example, in some cases, only search entries that have been searched a threshold number of times during a particular time period using a particular search engine are extracted. In some cases, only the top ranking identified search query entries (e.g., top 10, top 100, top 500) ranked based on search frequency are extracted.

Next, the extracted search query entries are classified as reference queries if, upon verification, the extracted search query entries are determined to be related to the subset of particular content (240). To classify the extracted search query entries as reference queries various suitable verification methods may be used.

For instance, in some implementations, a filter, algorithm, or combination thereof, may be used to determine a context of the extracted search query entries, a meaning of the extracted search query entries, and/or an application of the extracted search query entries. If the context, meaning, and/or application of an extracted search query entry is determined to be related to the subset of particular content, the extracted search query entry is classified as a reference query.

In some implementations, human review may be used to verify whether the extracted search query entries are related to the subset of the particular content. If an extracted search query entry is determined to be related to the subset of the particular content, the extracted search query entry is classified as a reference query.

Referring to FIG. 1, after obtaining seed terms and one or more reference queries (110), for each reference query, one or more co-occurring queries are identified (130). Co-occurring queries are queries that have been submitted by users of a search engine within a determined period of time of a reference query. The determined period of time may be any suitable time configured by an administrator of the search query classifier. The determined period of time may be, for example, 2 minutes, 5 minutes, 10 minutes, 30 minutes, or 1 hour. The determined period of time may include time before or after a reference query was submitted to the search engine. In some implementations, the determined period of time may be empirically determined.

It should be understood that any suitable method may be used to identify the one or more co-occurring queries. For example, search logs of the search engine or other databases of search queries may be examined and queries co-occurring with a reference query may be identified.

In some implementations, a particular count of the number of times a query co-occurs with a particular reference query is determined. In some implementations, a reference count of the number of times a query co-occurs with any reference query and a cumulative count of the number of times a query is entered or listed in the search log or databases of search queries. The reference count and the cumulative count may be used to determine a co-occurrence value (130). The co-occurrence value may be a ratio of the reference count to the cumulative count.

As an example, a query “where to purchase guns” may be received by a search engine one thousand times a day, and may co-occur with reference queries (e.g., “Columbine shooting anniversary,” “school shooting”) a hundred times a day. Accordingly, the query “where to purchase guns” would have a 100 to 1000 or 10% co-occurrence value. As another example, a query “child sex” may occur ten thousand times a day, and may co-occur with reference queries (e.g., “teen rape”) six hundred times a day. Accordingly, the query “child sex” would have a 600 to 10,000 or 6% co-occurrence value.

After the co-occurrence value is determined for a co-occurring query, the co-occurrence value is compared with a determined co-occurrence threshold to determine if the co-occurrence value for a co-occurring query satisfies the determined co-occurrence threshold (140).

If the co-occurrence value for a co-occurring query does not satisfy the determined co-occurrence threshold, the co-occurring query is labeled as unlikely associated with the subset of particular content and is not added to training data for the search query classifier (150).

In some implementations, if the co-occurrence value for a co-occurring query does not satisfy the determined co-occurrence threshold but is within a determined proximity of the co-occurrence threshold, the co-occurring query may be further verified. The further verification may include any suitable type of verification, such as a human review, to verify whether the co-occurring query is associated with the subset of particular content. If the further verification indicates that the co-occurring query is associated with the subset of particular content, the co-occurring query is assigned a label if the co-occurring query satisfies a criteria (160). The determined proximity may be set by an administrator of the search query classifier. For example, the determined proximity may be set to a threshold range (e.g., within 5 percent or 2 percent) of the co-occurrence threshold.

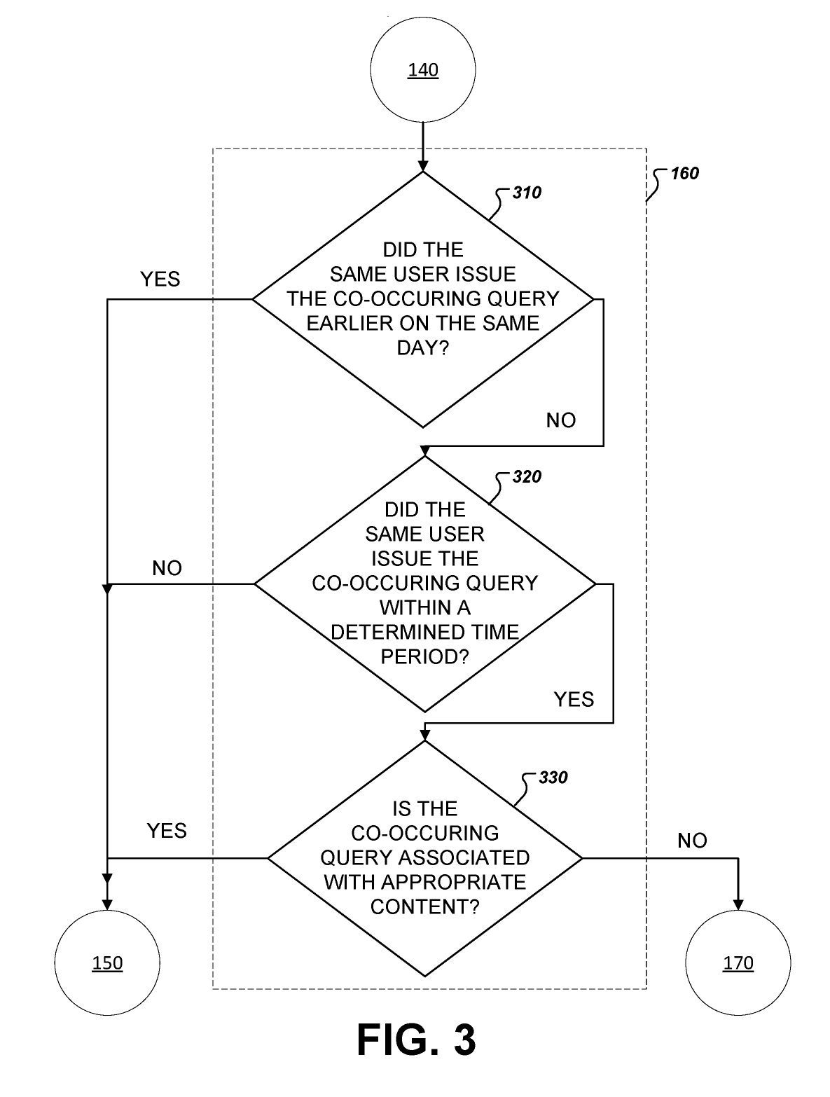

In some implementations, if the co-occurrence value for a co-occurring query does satisfy the determined co-occurrence threshold, the co-occurring query is assigned a label if the co-occurring query satisfies a criteria (160). An explanation of the criteria is provided in FIG. 3.

Referring to FIG. 3, a search record of the co-occurring query is examined to determine if the same user issued the co-occurring query earlier on the same calendar day (310). If the same user issued the co-occurring query earlier on the same calendar day, the co-occurring query is not added as training data for the search query classifier (150).

If the same user did not issue the co-occurring query earlier on the same calendar day, the search record of the co-occurring query is further examined to determine if the same user issued a reference query within the determined time period of entering the co-occurring query in the search query (320).

If the same user did not issue a reference query within the determined time period of entering the co-occurring query in the search query, the co-occurring query is not added as training data for the search query classifier (150). If the same user did issue a reference query within the determined time period of entering the co-occurring query in the search query, the co-occurring query is further examined to determine if the co-occurring query includes or is related to appropriate offensive content or appropriate sensitive content (330).

The administrator of the search query classifier may control the classification of content into different categories, such as, for example, appropriate sensitive content, inappropriate sensitive content, appropriate offensive content, and inappropriate offensive content. As an example, queries such as “how to shoot my classmates” may be classified as inappropriate sensitive content, whereas “school shooting” may be classified as appropriate sensitive content. In another example, queries such as “preteen sex” may be classified as inappropriate sensitive content and inappropriate offensive content, whereas “sex” or “pornography” may be classified as appropriate sensitive content and appropriate offensive content.

If the co-occurring query includes or is related to appropriate offensive content or appropriate sensitive content, training data associated with the co-occurring query is not added as training data for the search query classifier (150). If the co-occurring query includes or is related to inappropriate offensive content or inappropriate sensitive content, the co-occurring query is labeled as likely associated with the subset of particular content. The labeled co-occurring query is then provided to the search query classifier as training data for queries associated with the subset of particular content (170).

In some implementations, a labelled co-occurring query may be expanded to multiple queries that are similar but not identical. The multiple queries may be generated through various types of modifications of the labelled co-occurring query and added as training data along with the labelled co-occurring query. For example, in some cases, a modified or incorrect spelling of the labelled co-occurring query may be generated. In some cases, a labelled co-occurring query may be split into one or more character-ngrams to generate multiple queries associated with the labelled co-occurring query.

The multiple queries generated and added as training data increase the amount of training data and may result in the search query classifier being robust against common variations of queries associated with the subset of particular content.

In some implementations, after the search query classifier is trained, the trained search query classifier may be calibrated by sampling queries with different classifications and confidences and presenting the queries to human operators for classification. If a classification of a query by the search query classifier systematically disagrees with a classification of the query by human operators, a classification of the query may be corrected by a monotonic transformation function that maps the search query classifier's confidence values to those obtained from human operators.

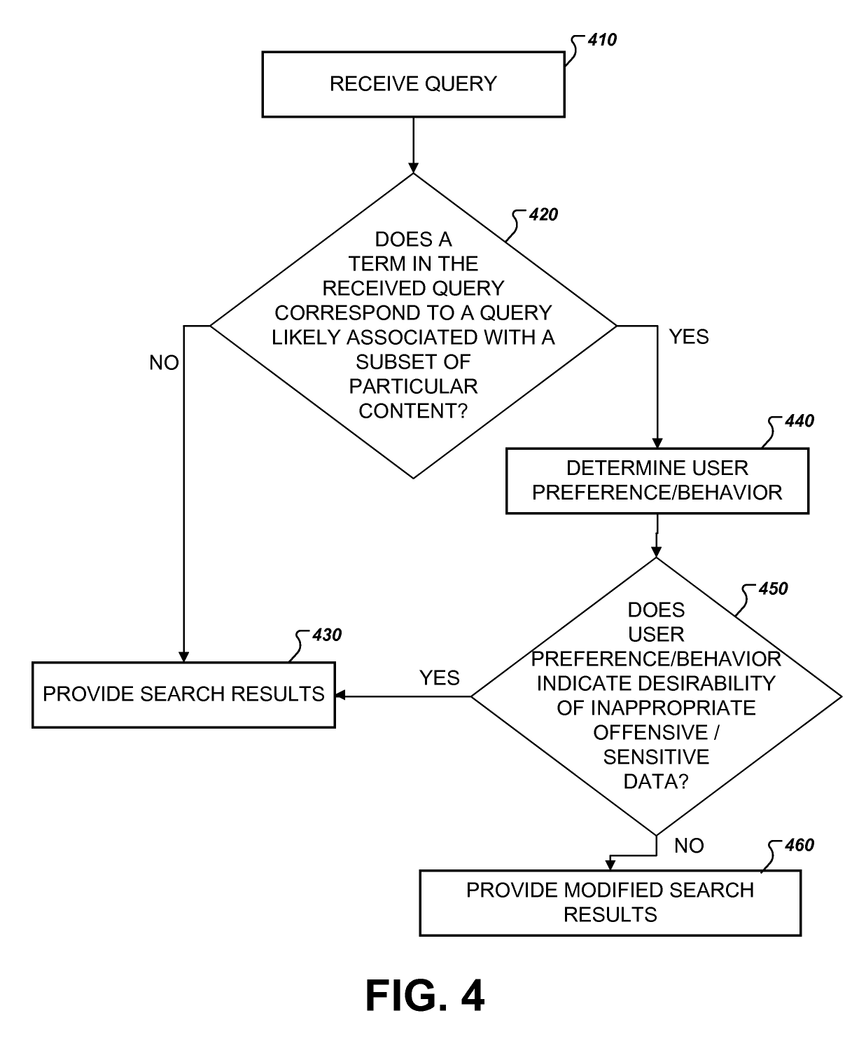

After the search query classifier is trained or trained and calibrated, the search query classifier may configure a search engine to modify search results in response to search queries that include the labeled co-occurring queries. Search engine receipt and output of data is described with reference to FIG. 4.

Referring to FIG. 4, a method of providing a search result according to a trained search query classifier is described. After a search query classifier has been trained according to the implementations described hereinabove, a search engine may receive a search query from a user (410). The search engine may determine if one or more terms in the received search query correspond to a query likely associated with a subset of particular content (420).

For example, when a user submits a query “how to poison children,” the search engine may determine that the submitted query corresponds to a query likely associated with a subset (e.g., child violence) of particular content for which the search query classifier has been trained in. In another example, a user may submit a query “naughty children.” In this case, the search engine may determine that the submitted query does not correspond to a query likely associated with a subset of particular content for which the search query classifier has been trained in.

If the one or more terms in the received search query do not correspond to a query likely associated with a subset of particular content, the search engine retrieves resources from a database and provides search results in response to the search query (430).

If the one or more terms in the received search query do correspond to a query likely associated with a subset of particular content, the search engine may determine user behavior or preferences (440). The search engine may use various suitable techniques to determine user behavior or preferences. The user behavior or preferences may include data indicative of subject matter, web pages, videos, images, and, in general, any content the user may be interested in obtaining information about.

In some implementations, the search engine may search the user's current or previous search session logs and, based on previously-submitted queries, determine user behavior or preferences.

In some implementations, the search engine may search the user's current search session log and, based on search results (e.g., images, links) selected by the user, determine user behavior or preferences.

In some implementations, a user may have provided an input, such as an activation of a filter (e.g., spoof content filter, pornography filter, under 18 filter, etc.) or button in the browser. Based on the user input, the search engine may determine user behavior or preferences.

After determining user behavior or preferences, the search engine determines if the user is interested in inappropriate offensive content or inappropriate sensitive content (450). For example, if the user has activated a child-lock or a filter (e.g., pornography filter, violent content filter), the search engine may determine that the user is not interested in search results that include inappropriate offensive content or inappropriate sensitive content. In another example, if the user has a history of viewing inappropriate offensive or sensitive content, the search engine may determine that the user is interested in search results that include inappropriate offensive or sensitive content.

If the search engine has determined that the user is not interested in search results that include inappropriate offensive or sensitive content, the search engine may modify the search results provided to the user (460). In some implementations, the search engine may modify the search results by decreasing the rank of resources that include inappropriate offensive or sensitive content. In some implementations, the search engine may suppress resources that include inappropriate offensive or sensitive content from the search results.

In some implementations, if the search engine has determined that the user is interested in search results that include inappropriate offensive or sensitive content, the search engine may provide search results without modifications (430). In some implementations, the search results may be modified by decreasing the ranking of resources that include inappropriate offensive or sensitive content to thereby limit the exposure of inappropriate offensive or sensitive content. For example, if the search engine has determined that the user is interested in search results that include inappropriate offensive or sensitive content such as child pornography, the search results may be modified such that child pornography content is suppressed (e.g., remove link to resource related to child pornography from search results, significantly lower ranking of resource related to child pornography) and, in some cases, not provided for a user.

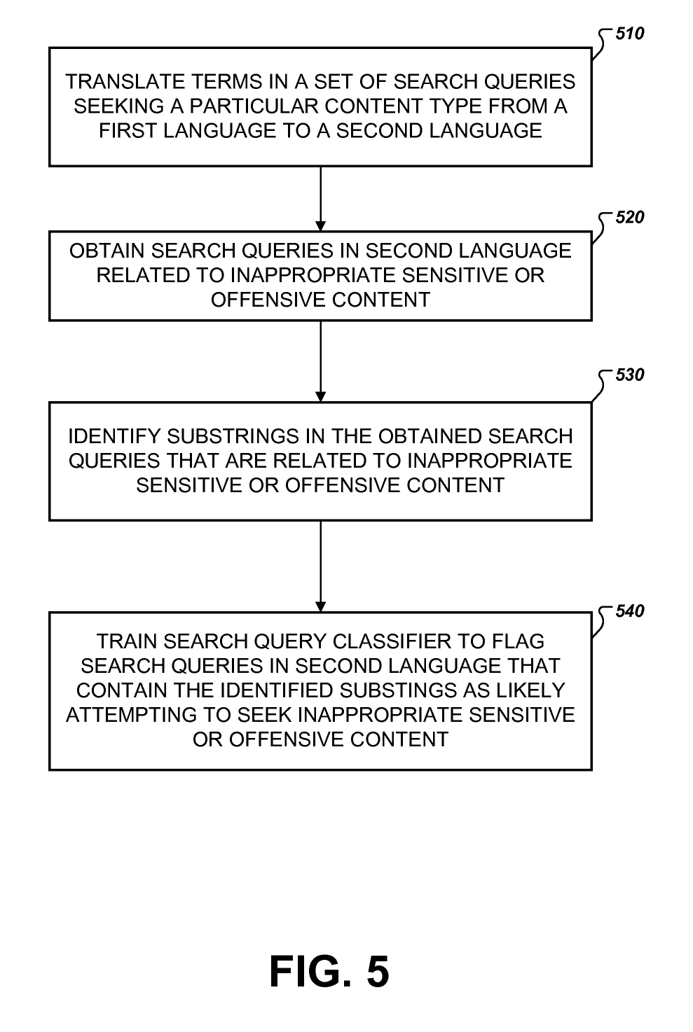

FIGS. 1-4 describe, in part, implementations through which a classifier can identify search queries seeking inappropriate sensitive or offensive content. Modified search results may be provided based on the training of the classifier. FIGS. 5-8 describe additional implementations in which the classifier can be trained to identify search queries seeking inappropriate sensitive or offensive content in multiple languages.

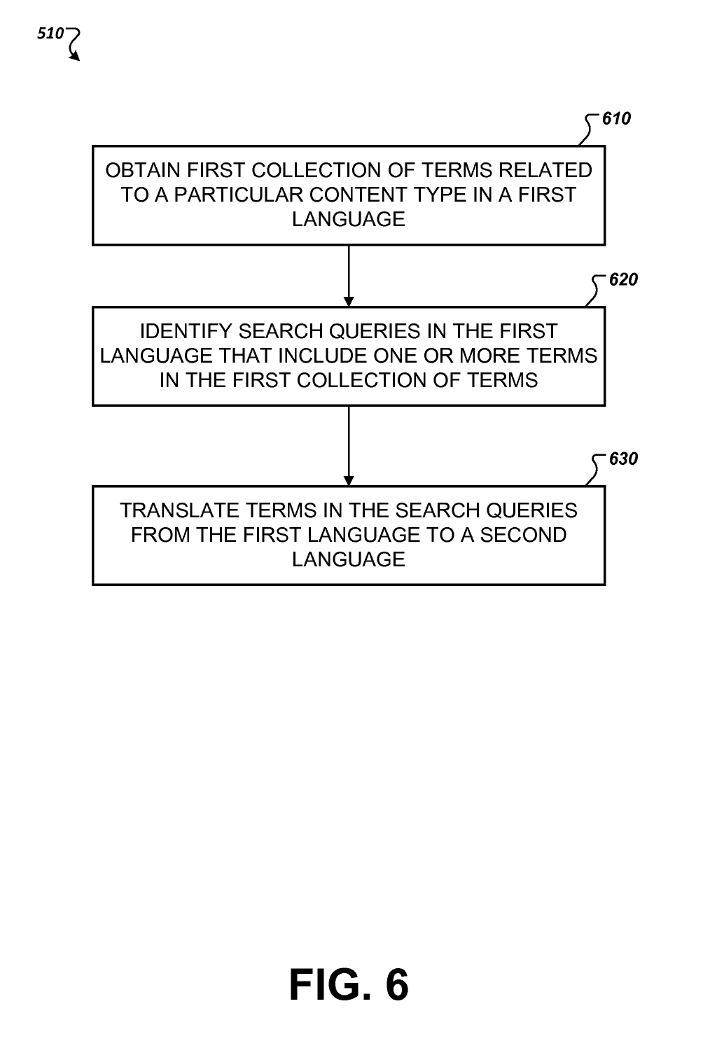

Referring to FIG. 5, a set of search queries seeking a particular type of content (e.g., child-related content) may be translated from a first language, such as English, to a second language (510). FIG. 6 describes this operation further.

A collection of terms related to the particular type of content (e.g., child-related content) may be obtained through various suitable means (610). For example, in some cases, one or more classifiers may be trained to detect terms used to obtain information related to the particular type of content. In some cases, a database including various terms that are related to the particular type of content may be generated by an administrator of the search query classifier.

The collected terms related to the particular type of content are used to identify search queries in the first language that include one or more of the collected terms (620). The search queries may be identified through various suitable methods. In some implementations, search logs or databases of search queries in the first language may be searched using, for example, a keyword match, to identify search query entries in the search logs or the databases of search entries with terms that match one or more of the collected terms.

In some implementations, only a select number of identified search queries that satisfy a criteria may be utilized. The criteria may include one or more criterion, such as a threshold criterion. For instance, a search query that satisfies a particular threshold (e.g., is one of the top 1,000 most frequently submitted search queries that includes a collected term) may be utilized.

Terms in the identified search queries may then be translated from the first language to a second language (630). It should be understood that the first language is not limited to English, and may be any other language with a large database of terms related to the particular type of content. It should also be understood that the second language may be any language other than the first language. In some implementations, the first language and second language may be different dialects of the same language.

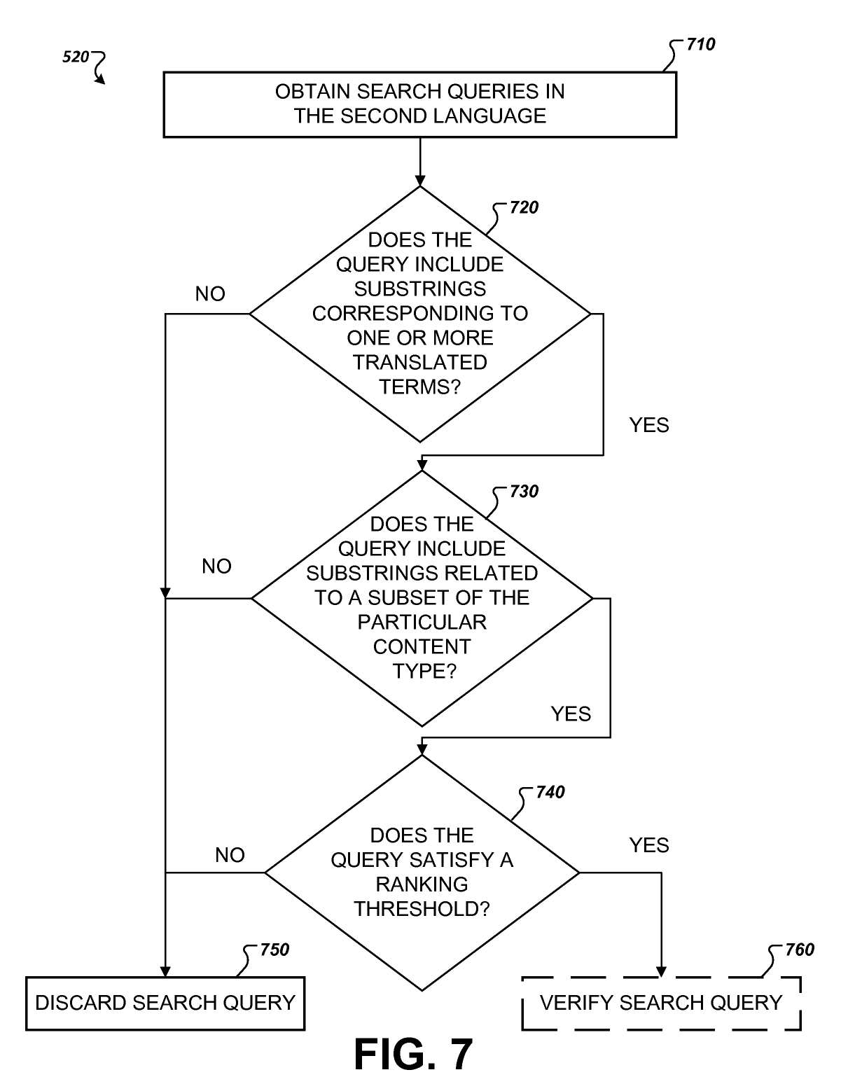

Referring back to FIG. 5, after translating terms in a set of search queries from the first language to the second language, search queries in the second language that are related to inappropriate sensitive or offensive content are obtained (520). FIG. 7 describes this operation further.

Referring to FIG. 7, search logs or databases of a search engine receiving search queries in the second language may be accessed to obtain a list of search queries in the second language (710). Each entry in the list of search queries is processed to determine whether the search query satisfies one or more criterion. The one or more criterion may include determining whether: (i) the search query includes a substring that includes one or more of the second-language terms obtained by translation in operation 630 (720); (ii) the search query includes a substring that includes a term related to a subset (e.g., violence, pornography) of the particular type of content that includes inappropriate sensitive or offensive content (730); and (iii) the search query satisfies a ranking threshold (740).

The ranking threshold may correlate to a search query popularity threshold or a number of times a search query is submitted by users of a search engine. For instance, a search query that ranks, for example, in the top 1000, 5000, or 10,000, may satisfy the ranking threshold. The ranking threshold may be set by an administrator of the search query classifier.

If the search query does not satisfy the one or more criterion (e.g., does not include a substring that includes one or more of the second-language terms obtained by translation, does not include a substring that includes a term related to the subset of the particular type of content, or does not satisfy the ranking threshold), the search query is discarded (750). If the search query satisfies the one or more criterion, the search query may, in some cases, be further verified (760).

The further verification may include verifying whether the search queries that satisfy the one or more criterion are related to the subset of the particular type of content. The verification may be performed by various suitable means. For example, in some implementations, a filter, algorithm, or combination thereof, may be used to determine a context of the search query, a meaning of the search query, and/or an application of the search query. If the context, meaning, and/or application of the search query is determined to be related to the subset of particular content (e.g., child pornography), the extracted search query entry is determined to be related to inappropriate sensitive or offensive content.

In some implementations, human review may be used to verify whether the search query is related to the subset of the particular content (e.g., child pornography). If the search query is determined to be related to the subset of the particular content, the search query is determined to be related to inappropriate sensitive or offensive content.

Referring back to FIG. 5, after obtaining search queries in the second language that are related to inappropriate sensitive or offensive content, substrings in the obtained search queries that are likely related to inappropriate sensitive or offensive content are identified (530). For example, for a German-language search query such as “internetseiten von denen man kinderpornos herunterladen kann,” the substring “kinderporno” may be identified as a substring likely related to child-pornography.

To identify substrings in the obtained search queries that are likely related to inappropriate sensitive or offensive content are identified, a set of substrings may be compiled from the search queries that satisfy the one or more criterion. Each substring may then be further evaluated to determine how frequently each substring is used in search queries in the second language. For instance, using search logs of the search engine or search query databases in the second language, a number of times a particular substring appears in all search queries in the second language received by the search engine and a number of times the particular substring appears in search queries that are classified as being related to inappropriate sensitive or offensive content (e.g., child pornography) are determined. A ratio of the number of times a particular substring appears in all search queries in the second language received by the search engine to the number of times the particular substring appears in search queries that are classified as being related to inappropriate sensitive or offensive content may provide information as to how often a particular substring is used for queries seeking inappropriate sensitive or offensive content.

For example, if the substring “kinderporno” is used in 98 out of a 100 search queries to seek child pornography content in the German language, the ratio for “kinderporno” may be 98/100.

The ratio for each substring may then be compared to a relevance threshold to determine if the ratio for each substring satisfies the relevance threshold. For example, if the relevance threshold is set to 0.6, any substring with a ratio of 0.6 or more may satisfy the relevance threshold. The relevance threshold may be set by an administrator of the classifier. Substrings that satisfy the relevance threshold are classified as being related to inappropriate sensitive or offensive content (e.g., child pornography).

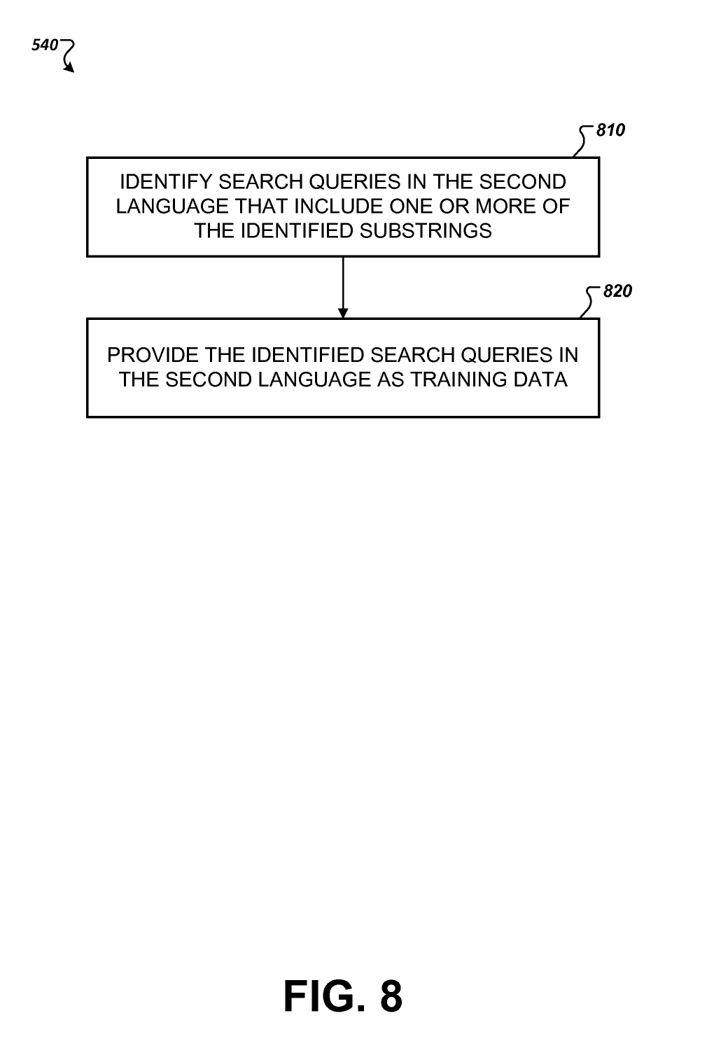

Referring back to FIG. 5, after identifying substrings that are related to inappropriate sensitive or offensive content, one or more classifiers (e.g., a search query classifier) are trained to flag search queries in the second language that contain the identified substrings as likely attempting to seek inappropriate sensitive or offensive content (540). FIG. 8 describes this operation further.

Using search logs of the search engine or search query databases in the second language, search queries in the second language that include one or more of the identified substrings are detected (810).

Referring to FIG. 8, in some implementations, search logs of the search engine or search query databases in the second language may be searched using, for example, a keyword match, to identify search queries that include one or more of the identified substrings (810). The identified search queries are then provided to the one or more classifiers as training data (820) so that a search engine may be able to identify search queries that are seeking inappropriate sensitive or offensive content.

Based on the implementations described above with respect to FIGS. 5-8, a database of search queries seeking inappropriate sensitive or offensive content in multiple languages can be developed. It should be understood that search queries seeking inappropriate sensitive or offensive content in a third language can be identified according to the implementations described hereinabove, for example, based, in part, on the search queries in the first or second languages. For example, search query terms in a first or second language can be translated to a third language in the manner described with reference to operation (510). A multiple language database can be further expanded using the implementations described above with respect to FIGS. 1-4. For example, in some implementations, search queries in a second language that satisfy one or more criterion (720, 730, 740) and are verified (760) may be provided as the reference queries in operation 110 or 240. As noted above, the verification of the search queries may be performed by various suitable means. For example, in some implementations, a filter, algorithm, or combination thereof, may be used to verify the search query. In some implementations, search queries that have been identified as including one or more of the identified substrings in operation 810 may be provided as the reference queries in operation 110 or 240. The reference queries may be used to detect co-occurring queries and obtain additional training data to train a search query classifier, as described above with respect to FIGS. 1-4.

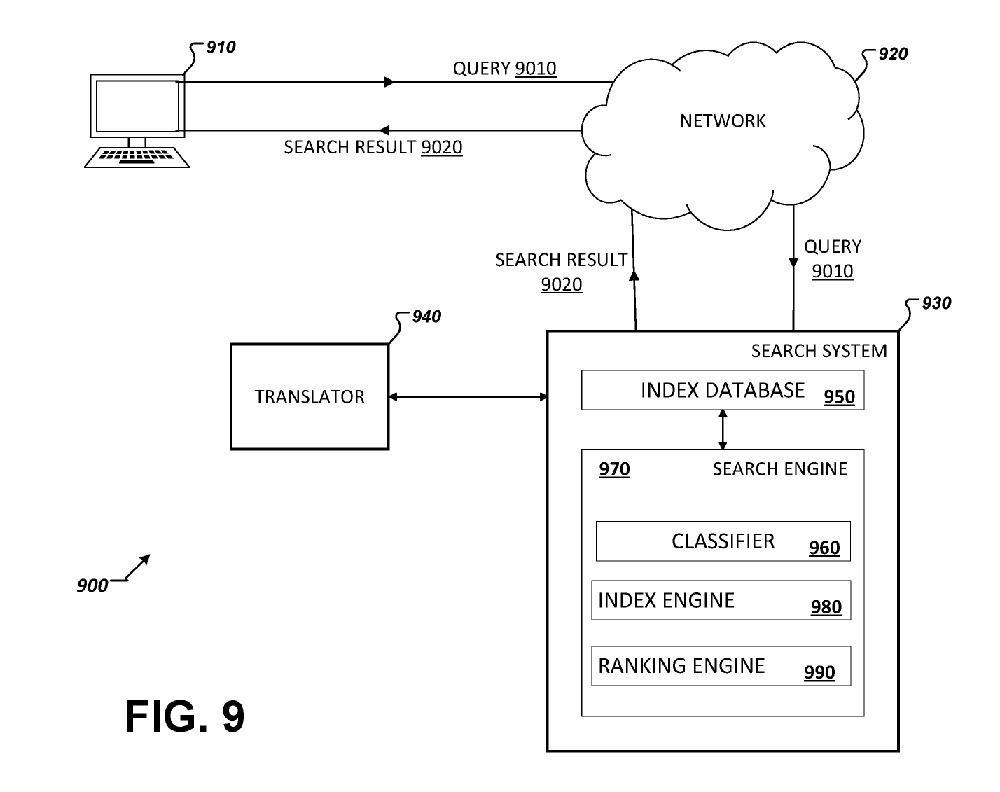

FIG. 9 depicts a block diagram illustrating a system 900 for implementing the training methods described hereinabove. A user may access a search system 930 via network 920 using a user device 910. The search system 930 may be connected to a translator 940. In some implementations, the translator 940 may be integrated with the search system 930.

User device 910 may be any suitable electronic device such as a personal computer, a mobile telephone, a smart phone, a smart watch, a smart TV, a mobile audio or video player, a game console, or a combination of one or more of these devices. In general, the user device 910 may be a wired or wireless device capable of browsing the Internet and providing a user with search results.

The user device 910 may include various components such as a memory, a processor, a display, and input/output units. The input/output units may include, for example, a transceiver which can communicate with network 920 to send one or more search queries 9010 and receive one or more search results 9020. The display may be any suitable display including, for example, liquid crystal displays, light emitting diode displays. The display may display search results 9020 received from the search system 930.

The network 920 may include one or more networks that provide network access, data transport, and other services to and from user device 910. In general, the one or more networks may include and implement any commonly defined network architectures including those defined by standards bodies, such as the Global System for Mobile communication (GSM) Association, the Internet Engineering Task Force (IETF), and the Worldwide Interoperability for Microwave Access (WiMAX) forum. For example, the one or more networks may implement one or more of a GSM architecture, a General Packet Radio Service (GPRS) architecture, a Universal Mobile Telecommunications System (UMTS) architecture, and an evolution of UMTS referred to as Long Term Evolution (LTE). The one or more networks may implement a WiMAX architecture defined by the WiMAX forum or a Wireless Fidelity (WiFi) architecture. The one or more networks may include, for instance, a local area network (LAN), a wide area network (WAN), the Internet, a virtual LAN (VLAN), an enterprise LAN, a layer 3 virtual private network (VPN), an enterprise IP network, or any combination thereof.

The one or more networks may include one or more databases, access points, servers, storage systems, cloud systems, and modules. For instance, the one or more networks may include at least one server, which may include any suitable computing device coupled to the one or more networks, including but not limited to a personal computer, a server computer, a series of server computers, a mini computer, and a mainframe computer, or combinations thereof. The at least one server may be a web server (or a series of servers) running a network operating system, examples of which may include but are not limited to Microsoft® Windows® Server, Novell® NetWare®, or Linux®. The at least one server may be used for and/or provide cloud and/or network computing. Although not shown in the figures, the server may have connections to external systems providing messaging functionality such as e-mail, SMS messaging, text messaging, and other functionalities, such as advertising services, search services, etc.

In some implementations, data may be sent and received using any technique for sending and receiving information including, but not limited to, using a scripting language, a remote procedure call, an email, an application programming interface (API), Simple Object Access Protocol (SOAP) methods, Common Object Request Broker Architecture (CORBA), HTTP (Hypertext Transfer Protocol), REST (Representational State Transfer), any interface for software components to communicate with each other, using any other known technique for sending information from a one device to another, or any combination thereof.

The translator 940 may be any suitable translator such as, for example, Google Translator. The translator 940 may execute one or more programs to translate words, terms, queries, and substrings from one language to another. The translator 940 may include or have access to linguistic databases that provide data for identifying and translating words, terms, queries, and substrings. In some cases, the linguistic databases may also include information that provides contextual use of words, terms, queries, and substrings in one or more languages.

It should be appreciated that while an example of the German language being a second language is described above, any language for which the translator 940 has translation capabilities may be used as the second language. Additionally, the first language is not limited to English, and may be any other language. The translator 940 is connected to the search system 930.

The search system 930 can be implemented, at least in part, as, for example, computer script running on one or more servers in one or more locations that are coupled to each other through network 920. The search system 930 includes an index database 950 and a search engine 970, which includes a classifier 960, an index engine 980, and a ranking engine 990.

The index database 950 stores indexed resources found in a corpus, which is a collection or repository of resources. The resources may include, for example, web pages, images, or news articles. In some implementations, the resources may include resources on the Internet. While one index database 950 is shown, in some implementations, multiple index databases can be built and used.

The index engine 980 indexes resources in the index database 950 using any suitable technique. In some implementations, the index engine 980 receives information about the contents of resources, e. g., tokens appearing in the resources that are received from a web crawler, and indexes the resources by storing index information in the index database 950.

The search engine 970 uses the index database 950 to identify resources that match a search query 9010. The ranking engine 990 ranks resources that match a search query 9010. The ranking engine 990 may rank the resources using various suitable techniques. The search engine 970 transmits one or more search results 9020 through the network 920 to the user device 910. In some implementations, the search engine 970 provides search results 9020 to the user device 910 according to the method of providing search results depicted in FIG. 4.

Classifier 960 may include one or more search query classifiers. The search query classifier 960 may be trained according to the method of training a search query classifier depicted in FIGS. 1-3 and 5-8. For example, in some implementations, the classifier 960 may classify search queries, in multiple languages, as likely seeking a subset of a particular content or as unlikely seeking a subset of a particular content. These search queries may be verified and identified as including one or more substrings related to inappropriate sensitive or offensive content, and subsequently provided as reference queries. The reference queries may be used to detect co-occurring queries and obtain additional training data to train a search query classifier to detect queries seeking inappropriate sensitive or offensive content.

A user device 910 can connect to the search system 930 to submit a query 9010. The submitted query 9010 is transmitted through network 920 to the search system 930. The search system 930 responds to the query 9010 by generating search results 9020, which are transmitted through the network 920 to the user device 910 in a form that can be presented to the user (e.g., as a search results web page to be displayed in a web browser running on the user device 910).

When the search query 9010 is received by the search engine 970, the search engine 970 may classify the search query 9010 using classifier 960 and identify relevant resources (i.e., resources matching or satisfying classified query). Based on the classification of the received search query 9010 and identified relevant resources, the search engine 970 may provide search results 9020 as described above with respect to FIGS. 1-8.

An advantage of the method described hereinabove is that a large database of search queries and query terms can be obtained in multiple languages and continuously updated with minimal human input. This large database of query terms can be used to train a search query classifier to detect queries seeking inappropriate sensitive or offensive content.

Embodiments and all of the functional operations and/or actions described in this specification may be implemented in digital electronic circuitry, or in computer software, firmware, or hardware, including the structures disclosed in this specification and their structural equivalents, or in combinations of one or more of them. Embodiments may be implemented as one or more computer program products, e.g., one or more modules of computer program instructions encoded on a computer readable medium for execution by, or to control the operation of, data processing apparatus. The computer readable medium may be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus may include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) may be written in any form of programming language, including compiled or interpreted languages, and it may be deployed in any form, including as a standalone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform actions by operating on input data and generating output. The processes and logic flows may also be performed by, and apparatus may also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both.

Elements of a computer may include a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer may not have such devices. Moreover, a computer may be embedded in another device, e.g., a tablet computer, a mobile telephone, a personal digital assistant (PDA), a mobile audio player, a Global Positioning System (GPS) receiver, to name just a few. Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory may be supplemented by, or incorporated in, special purpose logic circuitry.

To provide for interaction with a user, embodiments may be implemented on one or more computers having a display device, e.g., a cathode ray tube (CRT), liquid crystal display (LCD), or light emitting diode (LED) monitor, for displaying information to the user and a keyboard and a pointing device, e.g., a mouse or a trackball, by which the user may provide input to the computer. Other kinds of devices may be used to provide for interaction with a user as well; for example, feedback provided to the user may be any form of sensory feedback, e.g., visual feedback, auditory feedback, or tactile feedback; and input from the user may be received in any form, including acoustic, speech, or tactile input.

Embodiments may be implemented in a computing system that includes a back end component, e.g., as a data server, or that includes a middleware component, e.g., an application server, or that includes a front end component, e.g., a client computer having a graphical user interface or a Web browser through which a user may interact with an implementation, or any combination of one or more such back end, middleware, or front end components. The components of the system may be interconnected by any form or medium of digital data communication, e.g., a communication network.

The computing system may include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while actions are depicted in the drawings in a particular order, this should not be understood as requiring that such actions be performed in the particular order shown or in sequential order, or that all illustrated actions be performed, to achieve desirable results. Moreover, the separation of various system components in the embodiments described above should not be understood as requiring such separation in all embodiments, and it should be understood that the described program components and systems may generally be integrated together in a single software product or packaged into multiple software products.

Thus, particular embodiments have been described. Other embodiments are within the scope of the following claims. For example, the actions recited in the claims may be performed in a different order and still achieve desirable results.

What is claimed is:

1. A non-transitory computer-readable storage medium comprising instructions, which, when executed by one or more computers, cause the one or more computers to perform actions comprising:
obtaining, from a search engine, a set of terms related to a particular type of content in a second language based on search queries in a first language;
obtaining, from the search engine, search queries in the second language that include (i) a substring matching one or more terms related to the particular type of content in the second language and (ii) a substring in the second language related to a subset of the particular type of content;
classifying one or more substrings in the obtained search queries that include (i) the substring matching one or more terms related to the particular type of content in the second language and (ii) the substring in the second language related to the subset of the particular type of content, as being related to inappropriate sensitive or offensive content;
providing the classified one or more substrings as training data for training a search query classifier; and
training, using the training data, the search query classifier to classify search queries in the second language that contain the classified one or more substrings as attempting to seek the inappropriate sensitive or offensive content.

2. The non-transitory computer-readable storage medium of claim 1, wherein:
the particular type of content corresponds to child-related content;
the subset of the particular type of content corresponds to child pornography; and
the inappropriate sensitive of offensive content corresponds to images, video, and data that include child pornography.

3. The non-transitory computer-readable storage medium of claim 1, wherein obtaining the set of child-related terms in the second language based on search queries in the first language, comprises:
obtaining a first collection of terms related to the particular type of content in the first language;
identifying, from among a collection of search queries in the first language, the search queries in the first language that include one of more of the terms related to the particular type of content; and
translating terms included in the search queries that include the one of more of the terms related to the particular type of content to terms in the second language.

4. The non-transitory computer-readable storage medium of claim 1, wherein obtaining search queries in the second language that include (i) the substring matching one or more terms related to the particular type of content in the second language and (ii) the substring in the second language related to a subset of the particular type of content, comprises:
for each search query:
determining a number of times that the search query is listed in a collection of search queries in the second language; and
determining that the number of times satisfies a first threshold.

5. The non-transitory computer-readable storage medium of claim 1, wherein classifying one or more substrings in the obtained search queries that include (i) the substring matching one or more terms related to the particular type of content in the second language and (ii) the substring in the second language related to the subset of the particular type of content, as being related to inappropriate sensitive or offensive content, comprises:
generating a set of one or more substrings extracted from each of the obtained search queries;
for each substring in the set of one or more substrings:
determining (i) a frequency of occurrence of the substring in a collection of search queries in the second language, and (ii) a frequency of occurrence of the substring in search queries in the second language that are classified as related to the subset of the particular type of content; and
classifying the substring as being related to inappropriate sensitive or offensive content, or not being related to inappropriate sensitive or offensive content, based at least on (i) the frequency of occurrence of the substring in the collection of search queries in the second language, and (ii) the frequency of occurrence of the substring in search queries in the second language that are classified as related to the subset of the particular type of content.

6. The non-transitory computer-readable storage medium of claim 1, wherein providing the classified one or more substrings as training data for training the search query classifier to classify search queries in the second language that contain the classified one or more substrings as attempting to seek the inappropriate sensitive or offensive content, comprises:
identifying, in a collection of search queries in the second language, one or more search queries that include the one or more substrings classified as being related to inappropriate sensitive or offensive content; and
providing the identified one or more search queries as training data to the search query classifier.

7. The non-transitory computer-readable storage medium of claim 1, further comprising:
training the search query classifier, for a third language, to identify search queries in the third language that contain one or more substrings classified as being related to the inappropriate sensitive or offensive content based on one or more of (i) the search queries in the first language, or (ii) the training data for the second language.

8. A computer-implemented method comprising:
obtaining a first collection of one or more child-related terms in a first language;
identifying, from among a collection of search queries in a first language received from a search engine, a first set of search queries that each include one or more of the child-related terms;
generating a second collection of search terms in a second language based on the first set of search queries from the first language;
identifying, from among a collection of search queries in the second language received from the search engine, a second set of search queries in the second language;
for each of the search queries in the second set, determining whether the search query includes (i) a substring corresponding to a term in the second collection of search terms, and (ii) a substring corresponding to a term in the second language associated with child pornography;
for each of the search queries in the second set determined as including (i) a substring corresponding to a term in the second collection of search terms, and (ii) a substring corresponding to a term in the second language associated with child pornography, classifying the search query as (i) related to child pornography, or (ii) not related to child pornography;
generating a set of one or more substrings from each of the search queries that are classified as related to child pornography;
for each substring in the set of one or more substrings, determining (i) a frequency of occurrence of the substring in the collection of search queries in the second language that were received from the search engine, and (ii) a frequency of occurrence of the substring in the search queries that are classified as related to child pornography;
for each substring in the set of one or more of substrings, classifying the substring as (i) a child pornography-related substring or (ii) not a child-pornography-related substring, based at least on (i) the frequency of occurrence of the substring in the collection of search queries in the second language that were received from the search engine, and (ii) the frequency of occurrence of the substring in the search queries that are classified as related to child pornography;
identifying, in the second set of search queries in the second language, a subset of the search queries that each include one or more of the substrings that are classified as a child pornography-related substring; and
providing, as training data for training a classifier, the subset of the search queries that each include one or more of the substrings classified as child pornography-related substrings.

9. The computer-implemented method of claim 8, wherein identifying, from among the collection of search queries in the first language received from the search engine, the first set of search queries that each include one or more of the child-related terms, comprises:
determining a number of times that the search queries in the first language are submitted by users of the search engine; and
determining that the number of times satisfies a first particular threshold.

10. The computer-implemented method of claim 8, wherein identifying, from among the collection of search queries in the second language received from the search engine, the second set of search queries in the second language, comprises:
determining a number of times that the search queries in the second language are submitted by users of the search engine; and
determining that the number of times satisfies a second particular threshold.

11. The computer-implemented method of claim 8, wherein generating the second collection of search terms in the second language based on the first set of search queries from the first language, comprises:
translating the first set of search queries from the first language to the second collection of search terms in the second language.

12. The computer-implemented method of claim 8, further comprising:
determining that a subsequent search query in the second language is received by the search engine, the subsequent search query including the one or more of the substrings that are classified as a child pornography-related substring;
identifying one or more search queries in the second language that are received by the search engine within a determined period of time of receiving the subsequent search query; and
providing, as training data for training the classifier, the one or more search queries in the second language that are received by the search engine within the determined period of time of receiving the subsequent search query.

13. The computer-implemented method of claim 8, wherein classifying the substring as (i) a child pornography-related substring or (ii) not a child-pornography-related substring, comprises:
determining a ratio of (i) the frequency of occurrence of the substring in the collection of search queries in the second language that were received from the search engine to (ii) the frequency of occurrence of the substring in the search queries that are classified as related to child pornography; and
classifying the substring as (i) a child pornography-related substring or (ii) not a child-pornography-related substring based on the ratio satisfying a third particular threshold.

14. A system comprising:
one or more computers and one or more storage devices storing instructions that are operable and when executed by one or more computers, cause the one or more computers to perform actions comprising:
obtaining, from a search engine, a set of terms related to a particular type of content in a second language based on search queries in a first language;
obtaining, from the search engine, search queries in the second language that include (i) a substring matching one or more terms related to the particular type of content in the second language and (ii) a substring in the second language related to a subset of the particular type of content;
classifying one or more substrings in the obtained search queries that include (i) the substring matching one or more terms related to the particular type of content in the second language and (ii) the substring in the second language related to the subset of the particular type of content, as being related to inappropriate sensitive or offensive content;
providing the classified one or more substrings as training data for training a search query classifier; and
training, using the training data, the search query classifier to classify search queries in the second language that contain the classified one or more substrings as attempting to seek the inappropriate sensitive or offensive content.

15. The system of claim 14, wherein:
the particular type of content corresponds to child-related content;
the subset of the particular type of content corresponds to child pornography; and
the inappropriate sensitive of offensive content corresponds to images, video, and data that include child pornography.

16. The system of claim 14, wherein obtaining the set of child-related terms in the second language based on search queries in the first language, comprises:
obtaining a first collection of terms related to the particular type of content in the first language;
identifying, from among a collection of search queries in the first language, the search queries in the first language that include one of more of the terms related to the particular type of content; and
translating terms included in the search queries that include the one of more of the terms related to the particular type of content to terms in the second language.

17. The system of claim 14, wherein obtaining search queries in the second language that include (i) the substring matching one or more terms related to the particular type of content in the second language and (ii) the substring in the second language related to a subset of the particular type of content, comprises:
for each search query:
determining a number of times that the search query is listed in a collection of search queries in the second language; and
determining that the number of times satisfies a first threshold.

18. The system of claim 14, wherein classifying one or more substrings in the obtained search queries that include (i) the substring matching one or more terms related to the particular type of content in the second language and (ii) the substring in the second language related to the subset of the particular type of content, as being related to inappropriate sensitive or offensive content, comprises:
generating a set of one or more substrings extracted from each of the obtained search queries;
for each substring in the set of one or more substrings:
determining (i) a frequency of occurrence of the substring in a collection of search queries in the second language, and (ii) a frequency of occurrence of the substring in search queries in the second language that are classified as related to the subset of the particular type of content; and
classifying the substring as being related to inappropriate sensitive or offensive content, or not being related to inappropriate sensitive or offensive content, based at least on (i) the frequency of occurrence of the substring in the collection of search queries in the second language, and (ii) the frequency of occurrence of the substring in search queries in the second language that are classified as related to the subset of the particular type of content.

19. The system of claim 14, wherein providing the classified one or more substrings as training data for training the search query classifier to classify search queries in the second language that contain the classified one or more substrings as attempting to seek the inappropriate sensitive or offensive content, comprises:
identifying, in a collection of search queries in the second language, one or more search queries that include the one or more substrings classified as being related to inappropriate sensitive or offensive content; and
providing the identified one or more search queries as training data to the search query classifier.

20. The system of claim 14, wherein the one or more computers are configured to perform actions further comprising:
training the search query classifier, for a third language, to identify search queries in the third language that contain one or more substrings classified as being related to the inappropriate sensitive or offensive content based on one or more of (i) the search queries in the first language, or (ii) the training data for the second language.
